(19) United States
(12) Patent Application Publication
(10) Pub. No.: US 2023/0366379 A1
(43) Pub. Date: Nov. 16, 2023

(54) SYSTEM FOR GENERATING ENERGY BY EXPLOITING WIND AT A HEIGHT

(71) Applicant: WINDTIME S.R.L., MONCALIERI (IT)

(72) Inventor: Giovanni Vergnano, MONCALIERI (IT)

(21) Appl. No.: 18/013,671

(22) PCT Filed: Jul. 10, 2021
(86) PCT No.: PCT/IT2021/050214

§ 371 Date: Dec. 29, 2022

(30) Foreign Application Priority Data
Jul. 10, 2020 (IT) 102020000016783

(51) Int. Cl. F03D 9/32; F03D 9/25; F03D 5/00

(52) U.S. Cl. CPC F03D 9/322; F03D 5/015; F03D 9/25; F05B 2220/706

(57) ABSTRACT

An improved system for generating energy by exploiting wind at a height. The system comprising at least one generator placed on the ground and operatively connected to at least one device for capturing energy through at least one constraining element. The constraining element is designed to transfer mechanical energy generated, as traction force, from the device for capturing energy to the generator. Where the device is a non-constrained rotor, namely a rotor not connected to the constraining element, and is designed to convert wind energy at a height with the traction force having an intermediate direction between wind axis and a vertical line with respect to the ground.

The present invention refers to an improved rotor for a wind power generation system by exploiting wind at a height.

Rotors for electricity generation similar to that described in this invention are not known in the art.

Object of the present invention is solving the above prior art problems by providing an improved rotor without constraints capable of determining a bearing greater than gravity and the consequent rise in altitude of the system.

The above and other objects and advantages of this invention, as will result from the following description, are achieved with a system according to Claim 1.

Preferred embodiments and non-trivial variants of this invention form the subject of dependent claims.

It is understood that all attached claims form an integral part of this description.

It will immediately become obvious that countless variants and modifications (e.g. shape, size, arrangements and parts with equivalent functionality) can be made to what is described, without departing from the scope of the invention as it appears from the attached claims.

The present invention will be better described by some preferred embodiments thereof, provided as a non-limiting example, with reference to the attached drawings, in which:

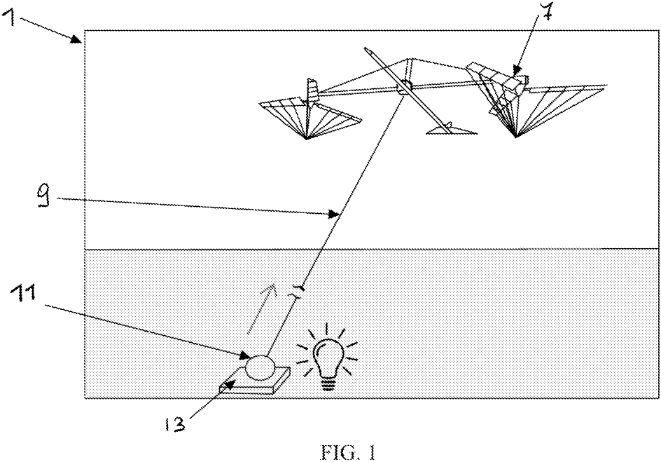

FIG. 1 shows a perspective view of an embodiment of the system perfected with the rotors in the active phase of energy production thanks to the lift generated by the profiles placed in rotation according to this invention;

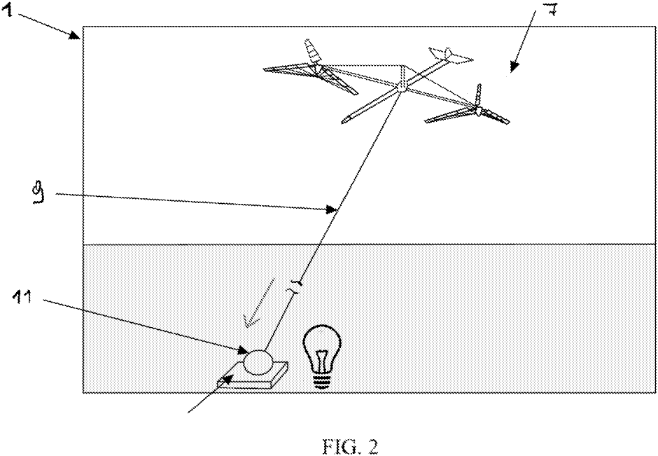

FIG. 2 shows a perspective view of the embodiment of the system perfected with the rotors in the passive phase necessary for the recovery of the start altitude of the active phase, characterized by an aerodynamic structure of rapid descent.

With reference to the Figures, the improved system 1 for energy generation by the exploitation of wind at a height of the present invention includes at least one generator 13 placed on the ground and operatively connected to at least one device 7 for the collection of energy through at least one constraining element 9, consisting of a long fiber cable, designed to transmit energy in the form of mechanical traction from device 7 to generator 13. Innovatively, in the system 1, the device 7 is an unconstrained rotor designed for converting wind energy at altitude by traction with intermediate direction between the wind axis and a vertical line to the ground. Preferably, the generator 13 is designed to be operated by at least one 11 winding coil to allow energy production.

The invention also concerns a process for the generation of energy by cycles by the exploitation of wind at a height using the system 1 described above, in which the process includes the steps of:
altitude ascent phase: the traction on the cable, generated by the lift of device 7, will transform mechanical energy into electricity thanks to generator 13;
rapid descent phase: phase with low energy consumption that allows to rewind the cable on the pulley of the generator and return to the start of the cycle.

1-3. (canceled)

10. A system for generating energy by exploiting wind at a height comprising: at least one generator placed on the ground and operatively connected to at least one device for capturing energy through at least one constraining element designed to transfer mechanical energy generated as traction from the device to the generator, wherein the device is a non-constrained rotor, namely a rotor not connected to the constraining element, designed to convert wind energy at a height with a traction force having an intermediate direction between wind axis and a vertical line with respect to the ground.

11. The system of claim 1, wherein the generator is designed to be actuated by at least one cable-winding coil adapted to allow producing energy.

12. A method for generating energy by exploiting wind at a height using the system of claim 1, the method comprising the steps of:
1) reaching a maximum operating height foreseen for the system;
2) alternating short steps of returning to a height of cycle start of the device, with a low energy consumption; and
3) returning to an initial height of the generating cycle through a stop or slowing-down of a rotation of kites or through a change of flight attitude.
